(19) United States
(12) Patent Application Publication
(10) Pub. No.: US 2021/0023834 A1
(43) Pub. Date: Jan. 28, 2021

(54) PRINTING BODY

(71) Applicant: Roto Hybrid Holdings Limited, Naas, Co. Kildare (IE)

(72) Inventors: Mark Jones, Naas, Co. Kildare (IE); Michael Keating, Naas, Co. Kildare (IE); Jürgen Engemann, Naas, Co. Kildare (IE); Tim Engemann, Naas, Co. Kildare (IE)

(21) Appl. No.: 16/640,823

(22) PCT Filed: Aug. 21, 2018
(86) PCT No.: PCT/EP2018/072565

§ 371 Date: Feb. 21, 2020

(30) Foreign Application Priority Data
Aug. 22, 2017 (GB) 1713441.2

(51) Int. Cl. B41C 1/05; B41C 1/18; B41F 13/11; B41N 1/06; B41N 1/20

(52) U.S. Cl. CPC B41C 1/05; B41C 1/184; B41N 1/20; B41N 1/06; B41F 13/11

(57) ABSTRACT

According to a first aspect of the invention, there is provided a method of processing a printing body, the printing body comprising a substrate and a diamond-like carbon (DLC) layer on the substrate, the method comprising engraving a printing pattern into the DLC layer. This method is advantageous, as it reduces the number of process steps required in processing the printing body, and reduces the loss of fine detail in the printing pattern.

The invention relates to a method of processing a printing body, a printing body and a method of printing.

Printing bodies, for example printing cylinders, are typically formed on a steel or aluminium substrate, to which copper is added, usually by a galvanic process (e.g. by electrolytic plating). The copper is engraved with a printing pattern, before the printing body is coated with a chrome layer to increase its hardness and wear resistance. In some cases a zinc or nickel alloy is deposited on the copper (or directly on the substrate) and engraved before the chrome layer is added. This process has a number of limitations, as explained below.

After the printing body has been used, typically many process steps are required to print a second printing pattern onto the printing body, as the printing body must be dechromed (usually in an acid bath), the engraved copper or zinc/nickel alloy is machined off (in a turning centre, for example a lathe), further copper or zinc/nickel alloy is added, the printing body machined to the required size (for example on a CFM, duostar or polishmaster) and re-engraved, before a further chrome coating can be added.

The application of the chrome coating to the engraved copper or zinc/nickel alloy can result in loss of fine detail in the printing pattern. This is because the application of the chrome layer results in a loss of cell definition by smoothing over/filling in of the engraved pattern at all printing depths due to the inhomogeneous nature of galvanic plating, but in particular at resolutions or depths of less than 20 microns, for example when security printing items such as bank notes, RFID, flexible packaging, and flexible printed circuits in solar panel manufacture. Galvanic (hard) chrome layers also often show micro-cracks, which can be detrimental for print quality, and/or gives the opportunity to allow water or other fluid through the cracks, which can oxidise the copper below which in turn can cause delamination of the chrome itself.

The galvanic process used to deposit the copper does not allow the properties of the copper (such as free surface energy, conductivity and hardness) to be varied through the printing body.

Also, the final printing surface would ideally be tougher, or more hard-wearing.

It is an aim of the present invention to solve or avoid problems with existing printing bodies, whether identified herein or elsewhere, or to provide an improved printing body or related methodology.

According to a first aspect of the invention, there is provided a method of processing a printing body, the printing body comprising a substrate and a diamond-like carbon (DLC) layer on the substrate, the method comprising engraving a printing pattern into the DLC layer. This method is advantageous, as it reduces the number of process steps required in processing the printing body, and reduces the loss of fine detail in the printing pattern. No further coating step is required after engraving the DLC, as the hardness of the DLC is sufficient for the DLC to be used as an image carrier for printing. As would be understood by the person skilled in the art, DLC is a class of amorphous carbon material that displays some of the typical properties of diamond. DLC exists in several different forms, each typically containing significant amounts of sp³ hybridized carbon atoms. The term Diamond-Like Carbon (DLC) describes a whole family of DLCs which can be tailored to meet specific requirements. Pure DLC is a class of amorphous carbon that displays some of the typical properties of diamond. A deposition method called Plasma-Enhanced Chemical Vapor Deposition (PECVD) is advantageous in example embodiments. The term PACVD (Plasma Assisted Chemical Vapor Deposition) is sometimes used, and can mean the same thing. A type of DLC deposited or provided in this way is named a-C:H, amorphous carbon with hydrogen included. Hydrogen is introduced by the PECVD-process. Key points of PECVD are (i) highest surface quality of all DLC-deposition methods, (ii) by the PECVD-process, multiple layers (even nano-layers) can be precisely grown to form a stack, (iii) the PECVD process allows to include foreign atoms (i.e. doping) into the DLC-matrix to control the free surface energy and to modify e.g. the thin film properties at will. This holds for the stack surface, as well as for buried (doped) DLC in the whole stack. Doping could be undertaken using, for example, hydrogen, nitrogen, silicon, metals, and so on.

In spite of DLC having been used previously to coat already engraved sub-layers (e.g. nickel or copper as described above), it has been found that, surprisingly, it is possible to engrave the DLC itself, thereby achieving the above-described advantages.

In one example, the engraving is laser engraving. The depth of laser engraving may be finely controlled to vary ink release properties (see below), which may vary across the printing pattern.

In one example, the DLC layer has a thickness of more than 2 microns. In one example, the DLC layer has a thickness of more than 3 microns, or more than 5 microns. In one example, the DLC layer has a thickness of more than 8 microns. In one example, the DLC layer has a thickness of more than 15 microns. For DLC-films with a thickness of 15 microns or more, multilayer DLC stacks with alternating tribological properties may be useful. Here, a PECVD process is beneficial to control the overall properties, for example layer (e.g. film) compressive stress.

In one example, the DLC layer comprises a DLC outer layer and a DLC sub-layer beneath the DLC outer layer, the DLC of the DLC sub-layer having a lower intrinsic compressive stress than the DLC of the DLC outer layer. In principle it is possible to have also a multiple of DLC sub-layers having different material properties. Sometimes, intrinsic compressive stress might be described or defined as hardness, because in general the higher the intrinsic compressive stress the higher the hardness. The lower intrinsic compressive stress of the DLC sub-layer is less prone to fracture than the DLC outer layer, which reduces the chance of failure of the printing body. Additionally, the lower intrinsic compressive stress of the DLC sub-layer may be deposited more quickly. The DLC of the DLC sub-layer may be a doped DLC, having foreign atoms doped therein to lower the intrinsic compressive stress. Typically, the DLC of the DLC outer layer is harder with a lower coefficient of friction compared to chrome, which improves wear resistance of surface which are often in contact with a doctor blade during printing. While the DLC of the DLC sub-layer is typically less hard than that of the outer layer, it is still very hard (e.g. 2000 HV). In another example, the DLC outer layer might comprise a doped DLC. In another example, any DLC layer (e.g. a single, sole layer) might comprise a doped DLC. Generally, the DLC of any layer can be modified with processing parameter changes such as pressures, incoming ion energy during deposition, temperature and functional doping to control properties of the layer, and/or between the layers. In one example, there may not necessarily be distinct layers. Instead, the properties of the DLC layer might vary through the layer, for example in continuous or step-wise manner. Such variation might be achieved by variable doping of foreign atoms. The DLC sub-layer may not be a distinct layer, but may be at a different depth within the DLC layer (i.e. and still be considered as a sub-layer).

In one example, the engraving comprises engraving the printing pattern into the DLC outer layer and the DLC sub-layer. Having the printing pattern in the DLC sub-layer provides better ink release during printing, which can reduce ink consumption. Varying the properties of the sub-layer is particularly advantageous when laser engraving is employed, as the laser engraving allows precise control of the depth of the engraving to correlate to the DLC in the sub-layer and the outer layer, thereby allowing properties within an engraved cell of an image carrier (i.e. the surface used for printing) to be varied. In some examples, the properties of the DLC in the DLC layer are varied across many sub-layers, and is tailored to the depth of laser engraving, allowing different printing results to be achieved in certain areas of the image carrier.

In one example, the properties of the DLC are controlled to vary across the DLC layer (for example by varying the doping across the DLC layer). This could be achieved by appropriately varying processing parameters controlling/within a vacuum chamber used in the formation of the layer. As such, the properties of the DLC in the DLC layer are predetermined and deliberately specified in combination with the printing pattern, and, where the properties also vary with depth, the depth to be engraved at each point on the printing pattern. This is in contrast to prior cylinders, in which the surface properties of the image carrier are completely uniform with zero control. This is particularly relevant to specialist printing such as in security printing.

In one example, the method comprises coating DLC to form the DLC layer onto the substrate before engraving the printing pattern into the DLC layer. In one example, the coating DLC is by vapour deposition process. In one example, the coating DLC is by a physical vapour deposition (PVD) process. In one example, the coating DLC is by a plasma-enhanced chemical vapour deposition (PECVD) process. These processes allow the deposition of DLC to be finely controlled, allowing foreign atoms to be doped in the DLC. This allows properties such as intrinsic compressive stress, hardness, coefficient of friction, conductivity and free surface energy control (i.e. the wettability of the surface, such as whether the surface is hydrophobic/hydrophilic and olephobic/oleophilic) to be varied throughout the DLC layer. The PECVD process occurs in a vacuum chamber, with the conditions in the chamber variable by computer to control the chamber's parameters and thereby vary the above-described properties. To form DLC from carbon, the carbon atoms have to impinge on the surface with a certain energy. That energy is typically above the thermal energy available by chemical vapor deposition. Therefore, DLC typically cannot be formed by pure thermal methods.

Having a more hydrophobic cell gives greater ink release properties in the engraved printing body. This is particularly useful in the lower tonal range (with a small engraved printing body), where it can reduce the need for extra solvents which are typically used in ink formulations to overcome loss of printing on the substrate in this (small cell) low range. Lower solvent usage/content can result in overall higher printing speeds, because there is less need for drying of the printed substrate in the printing machine drying units, which commonly restricts the maximum print speed. A-C:H (PECVD-process) is slightly hydrophobic. In terms of the so-called water-contact angle, a value of about 60 degrees can be achieved in example embodiments. Higher hydrophobicities can be achieved by adding foreign gaseous elements into the PECVD gas/plasma mixture.

PECVD is particularly advantageous when used in combination with laser engraving, as the precise control of depth of engraving which is possible during laser engraving allows the properties of the image carrier to be varied when the properties vary through the DLC layer. This means that the variation of properties with depth and depth of engraving can be easily varied to provide desired properties at the image carrier surface (e.g. to expose a hydrophilic surface, a hydrophobic surface or a conductive surface).

In one example, the method comprises removing at least a portion of the DLC layer to remove the printing pattern. This may be achieved in a vacuum chamber. In one example, the method comprises coating the printing body with DLC to reform the DLC layer, and engraving a second printing pattern into the DLC layer. This may be carried out in the same vacuum chamber in which the DLC layer is removed, thereby reducing the number of process steps required. As described above, the printing pattern can be replaced by the second printing pattern much more easily using this method. The ease with which the printing pattern can be removed is particularly advantageous in security printing applications, as the printing pattern can readily be removed to ensure it is kept private. Typically, the DLC layer is removed to just below the printing depth (e.g. where engraving is to a depth of 7 microns, DLC is removed to a depth of around 8 microns).

According to a second aspect of the invention, there is provided a printing body comprising a substrate and a DLC layer on the substrate, wherein the DLC layer comprises a printing pattern engraved in the DLC layer. Such a printing body is advantageous, as the number of process steps required to process the printing body are reduced, and fine detail is maintained in the printing pattern. Additionally, the printing pattern can be replaced much more easily with a second printing pattern (see above).

According to a third aspect of the invention, there is provided a method of printing using the printing body described above, the method comprising using an outer surface of the DLC layer as an image carrier for printing.

According to a fourth aspect of the invention, there is provided a method of re-processing a printing body, the method comprising removing at least a portion of a DLC layer of the printing body to remove a printing pattern in the DLC layer.

In one example, the method comprises coating the printing body with DLC to reform the DLC layer, and engraving a second printing pattern into the DLC layer.

For a better understanding of the invention reference is made, by way of example only, to the accompanying Figures, in which:

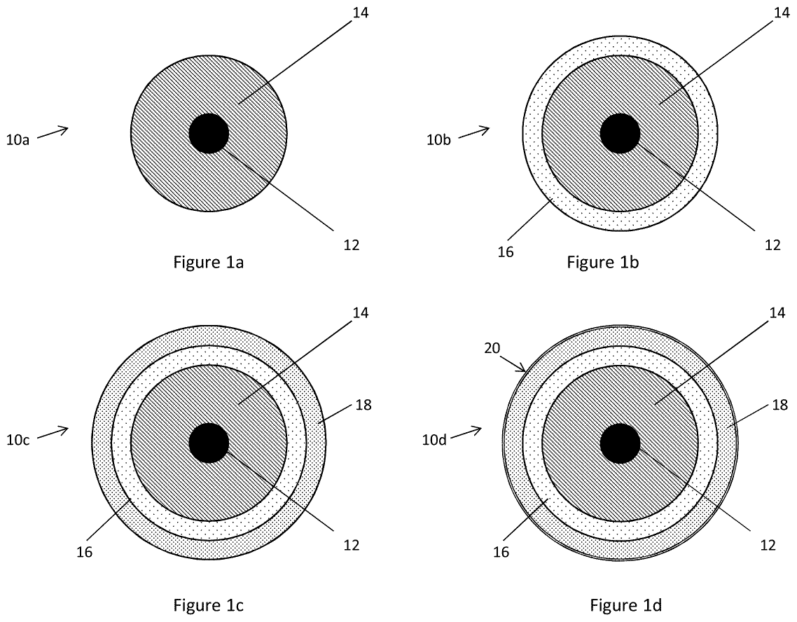

FIGS. 1a to 1d show cross-sectional views of a printing body in various stages of processing;

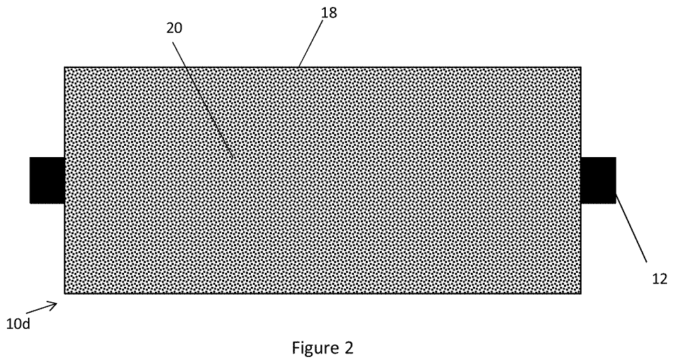

FIG. 2 shows a side view of a printing body; and

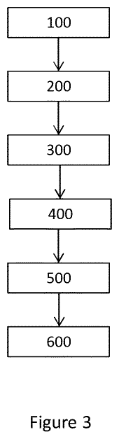

FIG. 3 shows a method of processing a printing body.

Referring to FIG. 1a, there is shown a first printing body 10a after a first stage of processing (FIG. 3: 100). The first printing body 10a comprises an axle 12 (or, in other examples, an external shaft of an internal bore or sleeve configuration. The first printing body 10a comprises a substrate 14. The substrate 14 is constructed from steel. The substrate 14 is substantially cylindrical, or at least is formed with a substantially cylindrical outer surface.

Referring to FIG. 1b, there is shown a second printing body 10b after a second stage of processing (FIG. 3: 200). The second printing body 10b comprises all of the features of the first printing body 10a, but with an additional feature of a DLC sub-layer 16, which is formed on the substrate 14. The DLC sub-layer 16 is formed with a substantially cylindrical outer surface.

Referring to FIG. 1c, there is shown a third printing body 10c after a third stage of processing (FIG. 3: 300). The printing body 10c comprises all of the features of the second printing body 10b, but with an additional feature of a DLC outer layer 18, which is formed on the DLC sub-layer 16. Together, the DLC sub-layer 16 and the DLC outer layer 18 form a DLC layer. The DLC of the DLC sub-layer 16 has a lower intrinsic compressive stress than the DLC of the DLC outer layer 18.

The DLC layer has a thickness of more than 3 microns, or more than 5 microns. More specifically, the DLC layer has a thickness of more than 8 microns. More specifically, the DLC layer has a thickness of more than 15 microns. In the present example, the DLC outer layer has a thickness of between 2 and 3 microns and the DLC sub-layer has a thickness of between 12 and 13 microns. In other examples, the DLC sub-layer has a thickness of between 17 and 18 microns. In other example, an outer DLC layer thickness may be between 3 and 8 microns.

In other examples, the DLC layer comprises a single layer of DLC, for example, having the substantially the same intrinsic compressive stress throughout.

Referring to FIG. 1d and FIG. 2, there is shown a fourth printing body 10d after a fourth stage of processing (FIG. 3: 400). The fourth printing body 10d comprises all of the features of the third printing body 10c, but with an additional feature of the DLC layer being engraved with a printing pattern 20. The printing pattern 20 is engraved directly in the DLC layer. More specifically, the printing pattern 20 is engraved directly in the DLC outer layer 18. The printing pattern 20 is engraved in the DLC outer layer 18 only.

In other examples, the printing pattern 20 is engraved through the DLC outer layer 18 and into the DLC sub-layer 16.

Referring to FIG. 3, there is shown a method of processing a printing body. During the first stage of processing 100, the first printing body 10a is received.

During the second stage of processing 200, the DLC sub-layer 16 is coated onto the substrate 14. The DLC sub-layer 16 is coated by a plasma-enhanced chemical vapour deposition process. The PECVD process occurs in a vacuum chamber (not shown), with the conditions in the chamber variable by computer to control the chamber's parameters and thereby vary the properties of the DLC. For example, foreign atoms may be doped into the DLC to allow properties such as intrinsic compressive stress, hardness, coefficient of friction, conductivity and surface energy control (e.g. hydrophobic/hydrophilic and olephobic/oleophilic properties) to be controlled in the DLC sub-layer 16 (or the DLC layer in general—see below).

During the third stage of processing 300, the DLC outer layer 18 is coated onto the DLC sub-layer 16. Again, the DLC outer layer 18 is coated by a plasma-enhanced chemical vapour deposition process. The PECVD process occurs in the vacuum chamber (not shown), with the conditions in the chamber variable by computer to control the chamber's parameters and thereby vary the properties of the DLC. For example, processing parameter control and foreign atoms may be doped into the DLC to allow properties such as intrinsic compressive stress, hardness, coefficient of friction, conductivity and surface energy control (e.g. hydrophobic/hydrophilic and olephobic/oleophilic) to be controlled in the DLC outer layer 18. Another important property is abrasive wear, which can be controlled, also by adjusting the PECVD process parameters. This means that coating of both the DLC sub-layer 16 and the DLC outer layer can occur in the same vacuum chamber, thereby simplifying the processing of the printing body. Generally, parameters which control the DLC (inner and outer, layers or similar) properties are vacuum/plasma chamber geometry including the cylinder positioning (electrical field and gas flow patterns), and the respective DLC forming process parameters. These can be controlled as needed.

During the fourth stage of processing 400, the printing pattern 20 is engraved into the DLC outer layer 18. The printing pattern 20 is engraved by laser engraving. In the present example, the printing pattern 20 is engraved only into the DLC outer layer 18. However, it will be appreciated that in other examples, the printing pattern 20 may be engraved into both the DLC outer layer 18 and the DLC sub-layer 16. This can be beneficial, particularly in cases where the properties of the DLC outer layer 18 and the DLC sub-layer 16 are different. As the depth of engraving with a laser can be precisely controlled, properties of an image carrier (e.g. ink release characteristics) can vary throughout the printing body.

After the fourth stage of processing, a printing stage 500 is carried out using the fourth printing body 10d. The surface of the DLC outer layer is used as an image carrier for printing. The printing body may be an Anilox roll, which is a type of rotogravure cylinder. The printing body may be used in many printing and metering applications, such as such as flexographic printing, printing of adhesives and glues in such processes and in corrugating machines, in which the printing body is used in the process of printing glue onto corrugated paper. Items such as security products, flexible packaging and printed circuits may be printed.

After printing, a re-writing stage 600 is carried out, in which the fourth printing body 10d is re-written with a second printing pattern (not shown). In order to do this, the fourth printing body 10d is returned to the vacuum chamber, where at least the DLC outer layer 18 (and in some examples the DLC sub-layer 16) is removed, to remove a printing pattern previous provided in that layer (which is to be contrasted with a DLC coating taking the form of, for example, underlying engraving). A further DLC layer is then added in the same vacuum chamber, before the second printing pattern is engraved into the DLC layer as above. Performing the removal and coating of DLC in the same vacuum chamber reduces the number of processing steps required in re-writing the printing body. There is no limit to the number of times that the printing body can be re-written. While the engraving may be carried out in the same chamber as the coating, it is also possible to engrave the printing body in a separate engraving machine.

DLC removal may be undertaken done by generally reversing the plasma deposition process. In this case volatile DLC (+foreign atoms possibly incorporated in the DLC layer) are formed by an appropriate choice of process gases and process parameters. That process is done in a vacuum chamber at low pressures. Another option would be to remove the DLC by a continuous sequential laser exposure with suitable wavelength. This could be done at ambient atmosphere. In doing so the reaction products are mainly CO and CO2. Both are volatile.

In isolation, or in combination with laser engraving, a user may conveniently process/re-process a printing body on site, and with fewer process steps than in the prior art. A single printing body can be used, processed and re-processed relatively easily, as opposed to needing many different bodies on site for printing of different patterns. The invention is therefore advantageous. The method is particularly advantageous for security printing application, where the printing and removal of a printing pattern can take place on site, avoiding the need to transport highly sensitive security images, and thereby avoiding the high costs (e.g. due to police or armed guards) associated with shipping to an offsite specialist engraver. Previously there was no way to remove the printing pattern on site, as the traditional wet chemistry galvanic processes (especially chrome) could not be carried out on site, due to cross contamination and health and safety concerns. The system described here requires no wet chemistry and has no such health and safety concerns.

It will be appreciated that the engraving described above can be undertaken using any appropriate approach, procedure or methodology and so on, for example by engraving in the form of one or more continuous lines or areas, or via engraving of discrete cells that may or may not combined to form a continuous line or (larger) area. For example, the process my be described or understood as an intaglio or gravure.

Although a few preferred embodiments have been shown and described, it will be appreciated by those skilled in the art that various changes and modifications might be made without departing from the scope of the invention, as defined in the appended claims.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of processing a printing body, the printing body comprising a substrate and a diamond-like carbon (DLC) layer on the substrate, the method comprising:
engraving a printing pattern into the DLC layer.

2. A method according to claim 1, wherein the engraving is laser engraving.

3. A method according to claim 1, wherein the DLC layer has a thickness of:
more than 3 microns; or
more than 8 microns; or
more than 15 microns.

4. A method according to claim 1, wherein the DLC layer comprises a DLC outer layer and a DLC sub-layer beneath the DLC outer layer, the DLC of the DLC sub-layer having a lower intrinsic compressive stress than the DLC of the DLC outer layer.

5. A method according to claim 4, wherein the DLC of the DLC sub-layer is a doped DLC having foreign atoms doped therein.

6. A method according to claim 4, wherein the engraving comprises engraving the printing pattern into the DLC outer layer and the DLC sub-layer.

7. A method according to claim 1, the method comprising coating DLC to form the DLC layer onto the substrate before engraving the printing pattern into the DLC layer.

8. A method according to claim 7, wherein the coating DLC is by a plasma-enhanced chemical vapor deposition process.

9. A method according to claim 1, the method comprising removing at least a portion of the DLC layer to remove the printing pattern.

10. A method according to claim 1, the method comprising coating the printing body with DLC to reform the DLC layer, and engraving a second printing pattern into the DLC layer.

11. A printing body comprising a substrate and a DLC layer on the substrate, wherein the DLC layer comprises a printing pattern engraved in the DLC layer.

12. A printing body according to claim 11, wherein the printing body is substantially cylindrical.

13. A method of printing using the printing body of claim 11, the method comprising using an outer surface of the DLC layer as an image carrier for printing.

14. A method of re-processing a printing body, the method comprising removing at least a portion of a DLC layer of the printing body to remove a printing pattern in the DLC layer.
